(19) United States
(12) Patent Application Publication
(10) Pub. No.: US 2019/0304354 A1
(43) Pub. Date: Oct. 3, 2019

(54) DISPLAY DEVICE, DRIVING DEVICE, AND DRIVING METHOD

(71) Applicant: HKC CORPORATION LIMITED, Shenzhen, Guangdong (CN)

(72) Inventor: Beizhou Huang, Shenzhen, Guangdong (CN)

(21) Appl. No.: 16/312,186

(22) PCT Filed: Jan. 12, 2018
(86) PCT No.: PCT/CN2018/072438

§ 371 Date: Dec. 20, 2018

(30) Foreign Application Priority Data
Oct. 24, 2017 (CN) 201711000442.6

(51) Int. Cl. G09G 3/20

(52) U.S. Cl. CPC G09G 3/2007; G09G 3/2092; G09G 2310/027; G09G 2310/0291; G09G 2330/028; G09G 2320/0276

(57) ABSTRACT

A display device, a driving device and a driving method are provided. The driving device comprises n first voltage dividers and n second voltage dividers, which are connected in series between a first gamma reference voltage and a second gamma reference voltage. A first end of an i-th first voltage divider and a first end of an i-th second voltage divider are connected and an i-th voltage output end is led out therefrom. A second end of the i-th first voltage divider and a second end of the i-th second voltage divider are connect and an (i+1)-th voltage output end is led out therefrom, n≥i≥1 and n, i are positive integers.

### CROSS-REFERENCE TO RELATED APPLICATION

This application is the International Application No. PCT/CN2018/072438 for entry into US national phase with an international filing date of Jan. 12, 2018, designating US, now pending, and claims priority to Chinese Patent Application No. 201711000442.6, filed on Oct. 24, 2017, the content of which is incorporated herein by reference in its entirety.

### BACKGROUND OF INVENTION

### 1. Field of the Invention

The embodiments of the present disclosure relate to the field of display technologies, particularly relate to a display device, a driving device, and a driving method.

### 2. Description of Related Art

With the progressive development of the display technology, display devices such as liquid crystal panels, displays, etc. are continuously developing towards light weight and thinness, large screen, low power consumption, and low cost. Conventional display products usually useTime Controller (TCON) or Screen Driving Board on the Printed Circuit Board (PCB) to process the drive signal and the control signal, and then output the processed signals to the display panel through the source driver chip and the gate driver chip to achieve the driving of the display panel.

In the existing art, the driving voltage output from the source driver chip to the display panel is generally generated by taking use of a plurality of voltage dividing resistors connected in series, which are arranged in the source driver chip, to divide the gamma reference voltage input from the source driver chip, and then the driving voltage corresponding to each gray scale of the display panel is output. Due to the factors of instability and objective errors caused in the process of manufacturing the display device, the actual resistance value of the voltage dividing resistor may be biased from the expected design resistance value, thus the gray scale of the display panel will be affected.

### BRIEF SUMMARY OF THE INVENTION

A first aspect of an embodiment of the present disclosure provides a driving device, comprising:
n first voltage dividers, which are connected in series between a first gamma reference voltage and a second gamma reference voltage; and
n second voltage dividers, which are connected in series between the first gamma reference voltage and the second gamma reference voltage; wherein a first end of an i-th first voltage divider and a first end of an i-th second voltage divider are connected and an i-th voltage output end is led out therefrom; and a second end of the i-th first voltage divider and a second end of the i-th second voltage divider are connect and an (i+1)-th voltage output end is led out therefrom;

wherein n≥i≥1, and wherein n and i are positive integers.

In an embodiment, each of the n first voltage dividers comprises at least one first resistor, and each of the n second voltage dividers comprises at least one second resistor.

In an embodiment, each of the n first voltage dividers comprises one first resistor, and n first resistors respectively of the n first voltage dividers are connected in series; and
each of the n second voltage dividers comprises one second resistor, and n second resistors respectively of the n second voltage dividers are connected in series.

In an embodiment, a first end of an i-th first resistor and a first end of an i-th second resistor are connected and an i-th voltage output end is led out therefrom; and
a second end of the i-th first resistor and a second end of the i-th second resistor are connected and an (i+1)-th voltage output end is led out therefrom.

In an embodiment, the driving device is applied to a display device, wherein the display device comprises a buffer controller, and the buffer controller is configured to generate the first gamma reference voltage and the second gamma reference voltage.

In an embodiment, wherein the buffer controller is one of a group consisting of a programmable gamma buffer, a buffer amplifier, and an operational amplifier.

In an embodiment, wherein the driving device further comprises:
n−1 third voltage dividers, wherein a j-th third voltage divider is connected between a second end of a j-th first voltage divider and a (j+1)-th voltage output end; and
n−1 fourth voltage dividers, wherein a j-th fourth voltage divider is connected between a second end of a j-th second voltage divider and a (j+1)-th voltage output end;
wherein j≤n−1, and wherein j is a positive integer.

In an embodiment, each of the n−1 third voltage dividers comprises at least one third resistor, and each of the n−1 fourth voltage dividers comprises at least one fourth resistor.

In an embodiment, each of the n first voltage dividers comprises one first resistor, each of the n second voltage dividers comprises one second resistor, each of the n−1 third voltage dividers comprises one third resistor, and each of the n−1 fourth voltage dividers comprises one fourth resistor.

A second aspect of an embodiment of the present disclosure further provides a driving method for a display device, wherein the display device comprises a source driver module, and the driving method comprises:
arranging first voltage dividers in the source driver module, connecting in series the n first voltage dividers between a first gamma reference voltage and a second gamma reference voltage;
arranging n second voltage dividers in the source driver module, connecting in series the n second voltage dividers between the first gamma reference voltage and the second gamma reference voltage;
connecting a first end of an i-th first voltage divider and a first end of an i-th second voltage divider and leading out an i-th voltage output end therefrom; and connecting a second end of the i-th first voltage divider and a second end of the i-th second voltage divider and leading out an (i+1)-th voltage output end therefrom;
wherein n≥i≥1, and wherein n and i are positive integers.

In an embodiment, each of the n first voltage dividers comprises at least one first resistor, and each of the n second voltage dividers comprises at least one second resistor.

In an embodiment, each of the n first voltage dividers comprises one first resistor, and n first resistors respectively of the n first voltage dividers are connected in series; and
each of n the second voltage dividers comprises one second resistor, and n second resistors respectively of the n second voltage dividers are connected in series.

In an embodiment, a first end of an i-th first resistor and a first end of an i-th second resistor are connected t and the i-th voltage output end is led out therefrom; and
a second end of the i-th first resistor and a second end of an i-th second resistor are connected and the (i+1)-th voltage output end is led out therefrom.

In an embodiment, the display device comprises a buffer controller, and the buffer controller is configured to generate the first gamma reference voltage and the second gamma reference.

In an embodiment, the buffer controller is one selected from a group consisting of a programmable gamma buffer, a buffer amplifier, and an operational amplifier.

In an embodiment, the driving device further comprises:
arranging n−1 third voltage dividers in the source driver module, connecting a j-th third voltage divider between a second end of a j-th first voltage divider and a (j+1)-th voltage output end; and
arranging n−1 fourth voltage dividers in the source driver module, connecting a j-th fourth voltage divider between a second end of a j-th second voltage divider and the (j+1)-th voltage output end;
wherein j≤n−1, and wherein j is a positive integer.

In an embodiment, each of the n−1 third voltage dividers comprises at least one third resistor, and each of the n−1 fourth voltage divider comprises at least one fourth resistor.

In an embodiment, each of the n first voltage dividers comprises one first resistor, each of the n second voltage dividers comprises one second resistor, each of the n−1 third voltage dividers comprises one third resistor, and each of the n−1 fourth voltage dividers comprises a fourth resistor.

In an embodiment, the source driver module is a Source-Chip on Film.

An embodiment of the present disclosure further provide a display device, which comprises:
a display panel;
a buffer controller, which is configured to output a first gamma reference voltage and a second gamma reference voltage;
a source driver module, which is respectively connected to the display panel and the buffer controller, and configured to drive the display panel using to the first gamma reference voltage and the second gamma reference voltage; and
, a driving device, disposed in the source driver module and comprising n first voltage dividers and n second voltage dividers, wherein the n first voltage dividers are connected in series between a first gamma reference voltage and a second gamma reference voltage; and the n second voltage dividers are connected in series between the first gamma reference voltage and the second gamma reference voltage; wherein a first end of an i-th first voltage divider and a first end of an i-th second voltage divider are connected and an i-th voltage output end is led out therefrom; and a second end of the i-th first voltage divider and a second end of the i-th second voltage divider are connected and an (i+1)-th voltage output end is led out therefrom; wherein n≥i≥1, and wherein n and i are positive integers; and
the driving device is configured to generate the first gamma reference voltage and the second gamma reference voltage, performed voltage division, and output voltage signals corresponding to each gray scale of the display panel to the display panel via the voltage output ends[D1].

In an embodiment of the present disclosure, two sets of voltage dividers are disposed in the driving device and each set of voltage dividers are connected in series between the first gamma reference voltage and the second gamma reference voltage. Specifically, the two correspondingly located voltage dividers of the two sets of dividing units are connected, and the voltage output end for outputting the driving voltage signal to the display panel is led out from the midpoint of the wire connected the two voltage dividers, which can effectively reduce the influence on the gray scale of the display panel caused by the resistance deviation of the voltage dividing resistors and improve the display effect.

### BRIEF DESCRIPTION OF THE DRAWINGS

In order to more clearly illustrate the technical solutions in the embodiments of the present disclosure, the drawings used in the description of the embodiments will be briefly described below. Obviously, the brief description of the drawings in the following are just part embodiments of the present disclosure, and without paying any creative work, those who skilled in the art may also obtain other drawings based on these ones.

FIG. 1 is a schematic structural diagram of a driving device provided by an embodiment of the present disclosure;

FIG. 2 is a schematic structural diagram of a driving device provided by another embodiment of the present disclosure;

FIG. 3 is a flowchart of a driving method for a display device provided by an embodiment of the present disclosure;

FIG. 4 is a flowchart of a driving method for a display device provided by another embodiment of the present disclosure;

FIG. 5 is a schematic structural diagram of a display device according to an embodiment of the present disclosure.

### DESCRIPTION OF THE PREFERRED EMBODIMENTS

In order to enable the people skilled in art to better understand the present disclosure, the technical solutions in the embodiments of the present disclosure will be clearly described below with reference to the accompanying drawings in the embodiments of the present embodiment. It is obvious that the described embodiments are just part of the embodiments, not all the embodiments. Based on the embodiments in the present disclosure, all the other embodiments obtained by those skilled in the art without paying creative efforts should fall within the scope of protection of the present disclosure.

The intention of the term “comprise” and its variations in the specification, claims and the above description of the drawings is to cover non-exclusive inclusions. For example, a process, method, a system, a product or a device comprising a series of steps or units are not limited to the listed steps or units, but optionally also comprises some steps or units not listed, or alternatively comprises other steps or units inherent to the process, method, product or device. Besides, the terms “first”, “second”, “third”, etc. are used to distinguish different objects, and not intended to describe a particular order.

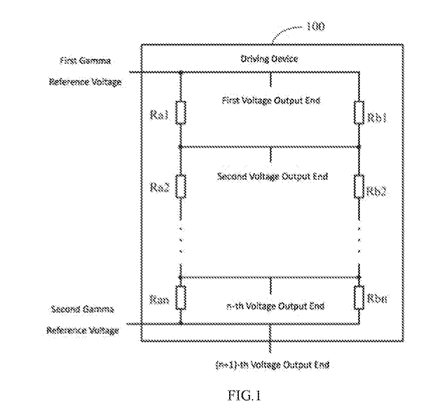

As shown in FIG. 1, an embodiment of the present disclosure provides a driving device 100, which comprises n first voltage dividers and n second voltage dividers, wherein n≥1, and wherein n is a positive integer.

In a specific application, the n first voltage dividers and the n second voltage divider may be any electronic components or a combination of a plurality of electronic components that both are capable of realizing voltage dividing function, for example, each of the n first voltage dividers and each of the n second voltage divider may be one resistor or a combination of a plurality of resistors.

In an embodiment, each of the n first voltage dividers comprises at least one first resistor and each of the n second voltage dividers comprises at least one second resistor.

In an embodiment, the first voltage divider and the second voltage divider are the same components.

As shown in FIG. 1, the first voltage divider and the second voltage divider are exemplarily shown as resistors, and the n first voltage dividers are exemplarily shown as a first resistor Ra1, a first resistor Ra2, . . . , and a first resistor Ran; besides, the n second voltage dividers are exemplarily shown as a second resistor Rb1, a second resistor Rb2, . . . , and a second resistor Rbn.

The connection relationship between the voltage dividers in the driving device 100 provided in this embodiment is:

the n first voltage dividers are connected in series between the first gamma reference voltage and the second gamma reference voltage, that is, the first resistor Ra1, the first resistor Ra2, . . . , and the first resistor Ran are sequentially connected in series, and, the first end of the first resistor Ra1 is connected to the first gamma reference voltage, and the second end of the first resistor Ran is connected to the second gamma reference voltage;
the n second voltage dividers are connected in series between the first gamma reference voltage and the second gamma reference voltage, that is, the second resistor Rb1, the second resistor Rb2, and the second resistor Rbn are sequentially connected in series, and, the first end of the second resistor Rb1 is connected to the first gamma reference voltage, and the second end of the second resistor Rbn is connected to the second gamma reference voltage;
the first end of the i-th first voltage divider and the first end of the i-th second voltage divider are connected and and an i-th voltage output end is led out therefrom, that is, the first end of the first resistor Rai and the first end of the second resistor Rbi are connected and an i-th voltage output end is led out therefrom;
the second end of the i-th first voltage divider and the second end of the i-th second voltage divider are connected and an (i+1)-th voltage output end is led out therefrom, that is, the second end of the first resistor Rai and the second end of the second resistor are connected and the (i+1)-th voltage output is led out therefrom;
wherein n≥i≥1 and i is a positive integer.

In this embodiment, according to the structure of the driving device shown in FIG. 1, the voltage calculation methods of the voltage output ends are as follows:
the voltage of the first voltage output end=the first gamma reference voltage;
the voltage of the second voltage output end=(the second end voltage Va1 of the first resistor Ra1+the second end voltage Vb1 of the second resistor Rb1)/2; wherein, Va1=the first gamma reference voltage−Ra1*(the first gamma reference voltage−the second gamma reference voltage)/(Ra1+Ra2+ . . . +Ran), Vb1=the first gamma reference voltage−Rb1*(the first gamma reference voltage−the second gamma reference voltage)/(Rb1+Rb2+ . . . +Rbn);
the voltage of the third voltage output end=(the second end voltage Va2 of the first resistor Ra2+the second end voltage Vb2 of the second resistor Rb2)/2; wherein, Va2=the first gamma reference voltage−(Ra1+Ra2)*(the first gamma reference voltage−second gamma reference voltage)/(Ra1+Ra2+ . . . +Ran), Vb2=the first gamma reference voltage−(Rb1+Rb2)*(the first gamma reference voltage−the second gamma reference voltage)/(Rb1+Rb2+ . . . +Rbn);

The voltage of the fourth voltage output end=(the second end voltage Va3 of the first resistor Ra3+the second end voltage Vb3 of the second resistor Rb3)/2; wherein, Va3=the first gamma reference voltage−(Ra1+Ra2+Ra3)*(the first gamma reference voltage−the second gamma reference voltage)/(Ra1+Ra2+ . . . +Ran), Vb3=the first gamma reference voltage−(Rb1+Rb2+Rb3)*(the first gamma reference voltage−the second gamma reference voltage)/(Rb1+Rb2+ . . . +Rbn);
and the voltages of the other voltage output ends are analogous;
the voltage of the (n+1)-th voltage output end=the second gamma reference voltage.

In a specific application, the first gamma reference voltage and the second gamma reference voltage may be generated by the buffer controller of the display device, and the buffer controller may be one of a group consisting of a programmable gamma buffer (P-Gamma IC), a buffer amplifier and an operational amplifier.

In an embodiment of the present disclosure, two sets of voltage dividers are disposed in the driving device and each set are connected in series between the first gamma reference voltage and the second gamma reference voltage. Specifically, two correspondingly located voltage dividers of the two sets of voltage dividers are connected, and the voltage output end for outputting the driving voltage signal to the display panel is led out from the midpoint of the wire connected the two voltage dividers, which can effectively reduce the influence on the gray scale of the display panel caused by the resistance deviation of the voltage dividing resistors and improve the display effect.

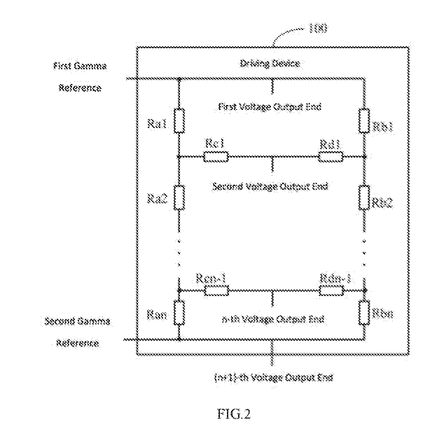

As shown in FIG. 2, in an embodiment of the present disclosure, the driving device 100 further comprises n−1 third voltage dividers and n−1 fourth voltage dividers.

In a specific application, the n−1 third voltage dividers and the n−1 fourth voltage dividers may be any electronic components or a combination of a plurality of electronic components both capable of realizing a voltage dividing function, for example, the third voltage divider and the fourth voltage divider may be one resistor or a combination of a plurality of resistors.

In an embodiment, each of the n−1 third voltage dividers comprises at least one third resistor, and each of the n−1 fourth voltage dividers comprises at least one fourth resistor.

In an embodiment, the third voltage divider and the fourth voltage divider are the same components.

As shown in FIG. 2, it is exemplarily shown that the n−1 third voltage dividers and the n−1 fourth voltage dividers are both resistors, and the n−1 third voltage dividers are exemplarily shown in FIG. 2 as the third resistor Rc1, the third resistor Rc2, . . . , and the third resistor Rcn−1; and the n−1 fourth voltage dividers are exemplarily shown in FIG. 2 as the fourth resistor Rd1, the fourth resistor Rd2, . . . , and the fourth resistor Rdn−1.

The connection relationship between the voltage dividers in the driving device 100 provided in this embodiment is:
the j-th third voltage divider Rcj is connected between the second end of the j-th first voltage divider Raj and the (j+1)-th voltage output end;
the j-th fourth voltage divider Rdj is connected between the second end of the j-th second voltage divider Rbj and the (j+1)-th voltage output end;
wherein j≤n−1, and wherein j is a positive integer.

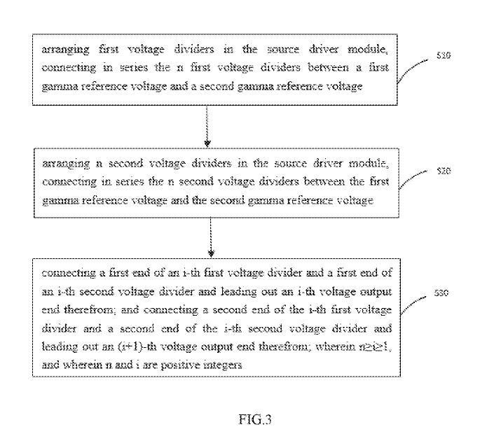

As shown in FIG. 3, an embodiment of the present disclosure provides a driving method for a display device, which is applied to the display device, and the display device comprises a source driver module.

In a specific application, the source driver module may be any components or circuits having a data driving function on pixels of the display panel, for example, a source driver IC, a Source-Chip on Film (S-COF), etc.

The driving method comprises:
at step S10, arranging first voltage dividers in the source driver module, connecting in series the n first voltage dividers between a first gamma reference voltage and a second gamma reference voltage;
at step S20, arranging n second voltage dividers in the source driver module, connecting in series the n second voltage dividers between the first gamma reference voltage and the second gamma reference voltage;
at step S30, connecting a first end of an i-th first voltage divider and a first end of an i-th second voltage divider and leading out an i-th voltage output end therefrom; and
connecting a second end of the i-th first voltage divider and a second end of the i-th second voltage divider and leading out an (i+1)-th voltage output end therefrom;
wherein n≥i≥1, and wherein n and i are positive integers.

In a specific application, the n first voltage dividers and the n second voltage dividers are any electronic components or a combination of a plurality of electronic components capable of realizing a voltage dividing function, for example, one resistor or a combination of a plurality of resistors.

In an embodiment, each of the n first voltage dividers comprises at least one first resistor and each of the n second voltage dividers comprises at least one second resistor.

In an embodiment, the first voltage divider and the second voltage divider are the same components.

In a specific application, when the n first voltage divider and the n second voltage divider are resistors, the circuit realized by the above method is the driving device shown in FIG. 1.

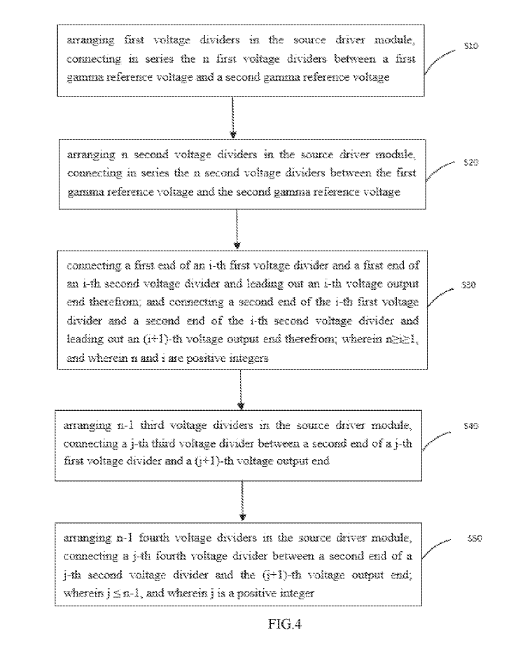

As shown in FIG. 4, an embodiment of the present disclosure about the driving method further comprises:
at step S40: arranging n−1 third voltage dividers in the source driver module, connecting a j-th third voltage divider between a second end of a j-th first voltage divider and a (j+1)-th voltage output end;
at step S50: arranging n−1 fourth voltage dividers in the source driver module, connecting a j-th fourth voltage divider between a second end of a j-th second voltage divider and the (j+1)-th voltage output end;
wherein j≤n−1, and wherein j is a positive integer.

In a specific application, the n−1 third voltage divider and the n−1 fourth voltage divider may be any electronic components or a combination of a plurality of electronic components capable of realizing a voltage dividing function, for example, one resistor or a combination of a plurality of resistors.

In an embodiment, each of the n−1 third voltage dividers comprises at least one third resistor, and each of the n−1 fourth voltage dividers comprises at least one fourth resistor.

In an embodiment, the third voltage divider and the fourth voltage divider are the same components.

In a specific application, when the n first voltage divider and the n second voltage divider are resistors, the circuit realized by the above method is the driving device shown in FIG. 2.

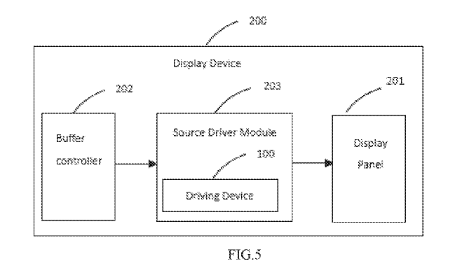

As shown in FIG. 5, an embodiment of the present disclosure provides a display device 200, comprising a display panel 201, a buffer controller 202, a source driver module 203, and the driving device 100 according to any one of the above embodiments.

In a specific application, the display panel may be any type of display panels, such as a liquid crystal display panel based on Thin Film Transistor Liquid Crystal Display (TFT-LCD) technology, a liquid crystal display panel based on Liquid Crystal Display (LCD) technology, an organic electroluminescence display panel based on Organic Electroluminescence Display (OLED) technology, a quantum dot light emitting diode display panel based on Quantum Dot Light Emitting Diode (QLED) technology, a curved surface display panel, etc.

The buffer controller 202 is configured to output a first gamma reference voltage and a second gamma reference voltage.

In a specific application, the buffer controller may be any components capable of outputting the first gamma reference voltage and the second gamma reference voltage. For example, the buffer controller may specifically be one of a group consisting of a programmable gamma buffer (P-Gamma IC), a buffer amplifier, and an operational amplifier.

The source driver module 203 is respectively connected to the display panel 201 and the buffer controller 202, configured to drive the display panel 201 based on the first gamma reference voltage and the second gamma reference voltage.

In a specific application, the source driver module may be any components or circuits having a data driving function on pixels of the display panel, for example, a source driver IC, a Source-Chip on Film (S-COF), etc.

The driving device 100 is disposed in the source driver module 203 for inputting the first gamma reference voltage and the second gamma reference voltage, performed voltage division, and output the voltage signals corresponding to each gray scale of the display panel 201 to the display panel 201 via the voltage output ends.

The modules in all the embodiments of the present disclosure may be implemented by a general integrated circuit, such as a Central Processing Unit (CPU), or by an Application Specific Integrated Circuit (ASIC).

The steps in the method of the embodiments of the present disclosure can be sequentially adjusted, merged, or deleted according to actual needs.

A person skilled in art can understand that all or part of the processes for implementing the above methods of the embodiments can be completed by computer programs that used to instruct the related hardware. Furthermore, the programs can be stored in a computer readable storage medium and when the programs are executed, the flow of each embodiment as described above can be comprised. Here, the storage medium may be a magnetic disk, an optical disk, a read-only memory (ROM), a random access memory (RAM), etc.

The above description shows only some preferred embodiments of the present disclosure and is not intended to limit the present disclosure. Any modifications, equivalent replacements, and improvements made within the spirit and principles of the present disclosure should be comprised in the protection of the present disclosure within the scope.

1. A driving device, comprising:
n first voltage dividers, which are connected in series between a first gamma reference voltage and a second gamma reference voltage; and
n second voltage dividers, which are connected in series between the first gamma reference voltage and the second gamma reference voltage;
wherein a first end of an i-th first voltage divider and a first end of an i-th second voltage divider are connected and an i-th voltage output end is led out therefrom; and
a second end of the i-th first voltage divider and a second end of the i-th second voltage divider are connect and an (i+1)-th voltage output end is led out therefrom;
wherein n≥i≥1, and wherein n and i are positive integers.

2. The driving device of claim 1, wherein each of the n first voltage dividers comprises at least one first resistor, and each of the n second voltage dividers comprises at least one second resistor.

3. The driving device of claim 2, wherein each of the first voltage dividers comprises one first resistor, and n first resistors respectively of the n first voltage dividers are connected in series; and
each of the n second voltage dividers comprises one second resistor, and n second resistors respectively of the n second voltage dividers are connected in series.

4. The driving device of claim 3, wherein a first end of an i-th first resistor and a first end of an i-th second resistor are connected and an i-th voltage output end is led out therefrom; and
a second end of the i-th first resistor and a second end of the i-th second resistor are connected and an (i+1)-th voltage output end is led out therefrom.

5. The driving device of claim 1, wherein the driving device is applied to a display device, wherein the display device comprises a buffer controller, and the buffer controller is configured to generate the first gamma reference voltage and the second gamma reference voltage.

6. The driving device of claim 5, wherein the buffer controller is one selected from a group consisting of a programmable gamma buffer, a buffer amplifier and an operational amplifier.

7. The driving device of claim 1, wherein the driving device further comprises:
n−1 third voltage dividers, wherein a j-th third voltage divider is connected between a second end of a j-th first voltage divider and a (j+1)-th voltage output end; and
n−1 fourth voltage dividers, wherein a j-th fourth voltage divider is connected between a second end of a j-th second voltage divider and a (j+1)-th voltage output end; and
wherein j≤n−1, and wherein j is a positive integer.

8. The driving device of claim 7, wherein each of the n−1 third voltage dividers comprises at least one third resistor, and each of the n−1 fourth voltage divider comprises at least one fourth resistor.

9. The driving device of claim 8, wherein each of the n first voltage dividers comprises one first resistor, each of the n second voltage dividers comprises one second resistor, each of the n−1 third voltage dividers comprises one third resistor, and each of the n−1 fourth voltage dividers comprises one fourth resistor.

10. A driving method for a display device, wherein the display device comprises a source driver module, and the driving method comprises:
arranging n first voltage dividers in the source driver module, connecting in series the n first voltage dividers between a first gamma reference voltage and a second gamma reference voltage;
arranging n second voltage dividers in the source driver module, connecting in series the n second voltage dividers between the first gamma reference voltage and the second gamma reference voltage;
connecting a first end of an i-th first voltage divider and a first end of an i-th second voltage divider and leading out an i-th voltage output end therefrom; and
connecting a second end of the i-th first voltage divider and a second end of the i-th second voltage divider and leading out an (i+1)-th voltage output end therefrom;
wherein n≥i≥1, and wherein n and i are positive integers.

11. The driving method of claim 10, wherein each of the n first voltage dividers comprises one first resistor, and n first resistors respectively of the n first voltage dividers are connected in series; and each of then second voltage dividers comprises one second resistor, and n second resistors respectively of the n second voltage dividers are connected in series.

12. The driving method of claim 11, wherein a first end of an i-th first resistor and a first end of an i-th second resistor are connected and the i-th voltage output end is led out therefrom; and
a second end of the i-th first resistor and a second end of an i-th second resistor are connected and the (i+1)-th voltage output end is led out therefrom.

13. The driving method of claim 10, wherein the first gamma reference voltage and the second gamma reference voltage are generated by a buffer controller of the display device.

14. The driving method of claim 13, wherein the buffer controller is one selected from a group consisting of a programmable gamma buffer, a buffer amplifier, and an operational amplifier.

15. The driving method of claim 10, wherein each of the n first voltage dividers comprises at least one first resistor, and each of the n second voltage dividers comprises at least one second resistor.

16. The driving method of claim 10, wherein the driving method further comprises:
arranging n−1 third voltage dividers in the source driver module, and connecting a j-th third voltage divider between a second end of a j-th first voltage divider and a (j+1)-th voltage output end; and
arranging n−1 fourth voltage dividers in the source driver module, and connecting a j-th fourth voltage divider between a second end of a j-th second voltage divider and the (j+1)-th voltage output end; and
wherein j≤n−1, and wherein j is a positive integer.

17. The driving method of claim 16, wherein each of the n−1 third voltage dividers comprises at least one third resistor, and each of the n−1 fourth voltage dividers comprises at least one fourth resistor.

18. The driving method of claim 17, wherein each of the n first voltage dividers comprises one first resistor, each of the n second voltage dividers comprises one second resistor, each of the n−1 third voltage dividers comprises one third resistor, and each of the n−1 the fourth voltage dividers comprises a fourth resistor.

19. The driving method of claim 10, wherein the source driver module is a Source-Chip on Film.

20. A display device, comprising:
a display panel;
a buffer controller, which is configured to output a first gamma reference voltage and a second gamma reference voltage;
a source driver module, which is respectively connected with the display panel and the buffer controller, and configured to drive the display panel with the first gamma reference voltage and the second gamma reference voltage; and
a driving device disposed in the source driver module, which is comprising n first voltage dividers, which are connected in series between a first gamma reference voltage and a second gamma reference voltage; and n second voltage dividers, which are connected in series between the first gamma reference voltage and the second gamma reference voltage; wherein a first end of an i-th first voltage divider and a first end of an i-th second voltage divider are connected and an i-th voltage output end is led out therefrom; and a second end of the i-th first voltage divider and a second end of the i-th second voltage divider are connect and an (i+1)-th voltage output end is led out therefrom; wherein n≥i≥1, and wherein n and i are positive integers; and
the driving device is configured to be input the first gamma reference voltage and the second gamma reference voltage, performed voltage division and output voltage signals corresponding to each gray scale of the display panel to the display panel via the voltage output ends.
